(19) United States
(12) Patent Application Publication
(10) Pub. No.: US 2025/0380143 A1
(43) Pub. Date: Dec. 11, 2025

(54) BLUETOOTH POINTING DEVICE PAIRING METHOD

(71) Applicant: Primax Electronics Ltd., Taipei (TW)

(72) Inventors: Ge-Hui Li, Taipei (TW); Bo-Jhih Chen, Taipei (TW); Chia-Han Li, Taipei (TW); Shi-Jie Zhang, Taipei (TW); Chih-Feng Chien, Taipei (TW)

(21) Appl. No.: 18/796,993

(22) Filed: Aug. 7, 2024

(30) Foreign Application Priority Data
Jun. 7, 2024 (CN) 202410740774.1

(51) Int. Cl. H04W 12/50; H04W 76/10

(52) U.S. Cl. CPC H04W 12/50; H04W 76/10

(57) ABSTRACT

A Bluetooth pointing device pairing method is provided. Firstly, a pairing command is issued from a Bluetooth dongle to a Bluetooth pointing device in response to a request command from the Bluetooth pointing device, and thus the Bluetooth pointing device is operated in a designated pairing mode. Then, the Bluetooth dongle generates and sends a random number set to a host. Then, a conversion process is performed to convert the random number set into a passkey value by the host, and an operating image corresponding to the passkey value is displayed. Then, an input operation is performed on the Bluetooth pointing device by a user according to the operating image, so that an operating result is generated. After the operating result is transmitted to the Bluetooth dongle, a comparison process is performed on the operating result to determine whether the pairing is completed.

### FIELD OF THE INVENTION

The present invention relates to a Bluetooth pointing device pairing method, and more particularly to a pairing method for allowing a Bluetooth Low Energy (BLE) device to be effectively paired with a dongle in a passkey entry pairing mode.

### BACKGROUND OF THE INVENTION

Nowadays, when a Bluetooth Low Energy (BLE) device is paired with a host that transmits data in a Bluetooth manner, both parties are paired in one of four pairing modes according to their input and output capabilities. The four pairing modes include a Just Works pairing mode, a numerical comparison pairing mode, a passkey entry pairing mode and an out-of-band pairing mode.

The Just Works pairing mode is usually used for pairing the devices without the displaying or inputting functions, e.g., Bluetooth headsets. As known, the headset has no screen to display information and no keyboard to input numbers. Consequently, if this pairing mode is selected, the pairing purpose can be achieved as long as a connection request is actively issued. However, the pairing process cannot be seen by the user.

In the numerical comparison pairing mode, both parties are required to display a set of 6-bit values. For example, in order to pair two mobile phones have respective screens, the user will compare whether the values displayed on both parties are consistent. If the values displayed on both parties are identical, the pairing process can be completed. In other words, this pairing mode requires that both parties to be paired need to be equipped with screens or display units. In addition, this pairing mode allows the user to input a “yes” or “no” response.

In the passkey entry pairing mode, the device to be paired (e.g., a Bluetooth keyboard) is required to input a set of 6-digit value displayed on the connected host as a password, and then both parties correspondingly generate encrypted information and interactively confirm. If the inputted value is correct, the pairing process is completed. In other words, this pairing mode requires that the paired device is equipped with a numeric keyboard that can be used for numeric input.

In the out-of-band pairing mode, the two devices to be paired are required to use other means to exchange the pairing information outside the Bluetooth low energy data channel. For example, a Bluetooth speaker with a near field communication (NFC) functionality can transmit encrypted information with the host. In addition to the near field communication (NFC) technology, other transmission methods can also be implemented. However, this pairing mode still has some disadvantages. For example, in accordance with the near field communication (NFC) technology, the Bluetooth speaker needs to have a built-in NFC tag, and the host connected to the Bluetooth speaker needs to be equipped with an NFC card reader.

Except for the Just Works pairing mode, the other three pairing modes of the above four paring modes have associated comparison or verification designs in the matching process. Consequently, the matching results of these three pairing modes are less likely to be wrong, or the information security protection function is achieved because the Man-In-The-Middle (MITM) attacks can be effectively avoided. In other words, the uses of the three pairing modes can authenticate the identities of both parties to prevent the man-in-the-middle (MITM) attacks. However, additional hardware costs such as the display unit, the numeric keyboard or the near-field communication unit (e.g., tags or card readers) are required.

However, since the general Bluetooth low energy mouse does not have the built-in display unit, numeric keyboard or near field communication unit, only the Just Works pairing mode can be selected when the Bluetooth low energy mouse is paired with a host. For example, during the process of paring the mouse with the host, the mouse will notify the host that it has no input and no output capabilities. After receiving the notification from the mouse, the host will select the Just Works pairing mode for pairing.

As mentioned above, the use of the Just Works pairing mode has the lowest hardware requirements and the lowest cost for this type of Bluetooth low energy device. However, this type of device cannot perform identity authentication for both parties. That is, it is unable to prevent the man-in-the-middle (MITM) attacks during operation. Consequently, in addition to the possibility of pairing errors, there are also concerns about the information security.

### SUMMARY OF THE INVENTION

An object of the present invention provides a Bluetooth pointing device pairing method. This pairing method allows a Bluetooth low energy (BLE) device such as a mouse to be effectively paired with a dongle in a passkey entry pairing mode complying with the Bluetooth transmission standard without the need of adding additional hardware configurations. As a consequence, the hardware setup cost is reduced, and the information security protection function to avoid the man-in-the-middle (MITM) attacks is achieved.

In accordance with an aspect of the present invention, a Bluetooth pointing device pairing method is applied to a host, a Bluetooth dongle and a Bluetooth pointing device. The Bluetooth dongle is in communication with the host. The Bluetooth pointing device pairing method includes the following steps. Firstly, a request command is issued from the Bluetooth pointing device to the Bluetooth dongle. Then, a pairing command is issued from the Bluetooth dongle to the Bluetooth pointing device in response to the request command, and thus the Bluetooth pointing device is operated in a designated pairing mode. Then, a random number process is performed to generate a random number set by the Bluetooth dongle, and the random number set is sent to the host. Then, a conversion process is performed to convert the random number set into a passkey value by the host, and an operating image corresponding to the passkey value is displayed. Then, an input operation is performed on the Bluetooth pointing device by a user according to the operating image, so that an operating result is generated. After the operating result is transmitted to the Bluetooth dongle, a termination command is issued to the Bluetooth dongle by the user in a predetermined manner. Then, the Bluetooth dongle and the Bluetooth pointing device performs a comparison process on the operating result to determine whether a pairing between the Bluetooth dongle and the Bluetooth pointing device is completed.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of an electronic system using a Bluetooth pointing device pairing method according to an embodiment of the present invention;

FIG. 2 is a flowchart of a Bluetooth pointing device pairing method according to an embodiment of the present invention;

FIG. 3 is a schematic diagram illustrating the operating image shown on the display screen of the host; and

FIG. 4 is a flowchart of the comparison process in the Bluetooth pointing device pairing method according to the embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention provides a Bluetooth pointing device pairing method. An example of the Bluetooth pointing device pairing method will be described as follows.

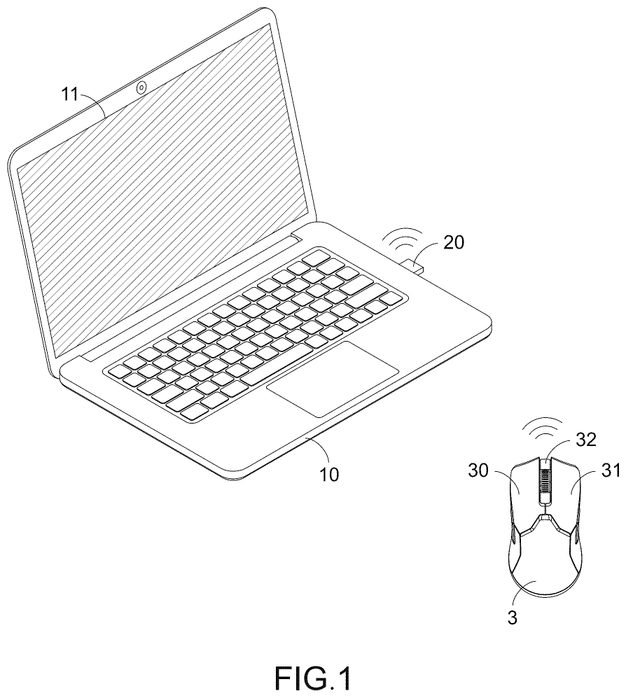

FIG. 1 schematically illustrates the architecture of an electronic system using a Bluetooth pointing device pairing method according to an embodiment of the present invention. As shown in FIG. 1, the electronic system includes a host 10, a Bluetooth dongle 20 and a Bluetooth pointing device 3.

As shown in FIG. 1, the Bluetooth dongle 20 is installed on the host 10. The Bluetooth dongle 20 is a Bluetooth transmission interface that is designed according to a universal serial bus (USB) specification. Consequently, the Bluetooth dongle 20 can be installed on a transmission interface (not shown) of the host 10 complying with the USB specification. In this embodiment, the host 10 is illustrated by a notebook computer, and the Bluetooth pointing device 3 is especially a Bluetooth low energy (BLE) device. For illustration, the Bluetooth pointing device 3 is a mouse with plural buttons. These buttons include a left button 30, a middle button 32 and a right button 31. For example, the middle button 32 is a scroll wheel module that can be scrolled and pressed.

In some embodiments, the Bluetooth pointing device 3 and the Bluetooth dongle 20 can be integrated as a Bluetooth pointing module. That is, the Bluetooth pointing device 3 and the Bluetooth dongle 20 are collaboratively formed as an integral product design. The Bluetooth dongle 20 is in communication with the host 10. In addition, the wireless signal transmission between the Bluetooth pointing device 3 and the Bluetooth dongle 20 can be established according to the Bluetooth communication protocol. It is noted that numerous modifications may be made. For example, in some other embodiments, the Bluetooth dongle is an accessory of the host 10.

In accordance with a feature of the present invention, the Bluetooth pointing device 3 and the Bluetooth dongle 20 are equipped with respective firmware components to execute the Bluetooth pointing device pairing method. Alternatively, the procedures of the Bluetooth pointing device pairing method are stored as operation program codes. The operation program codes are stored in respective flash memories (not shown) of the Bluetooth pointing device 3 and the Bluetooth dongle 20 and executed by their processors. Furthermore, in order to pair the Bluetooth pointing device 3 with the Bluetooth dongle 20, an operating program corresponding to the Bluetooth pointing device 3 and the Bluetooth dongle 20 is loaded in the host 10. The host 10 includes a display screen 11. When the operating program is executed, a screen image is shown on the display screen 11 so as to be viewed by the user.

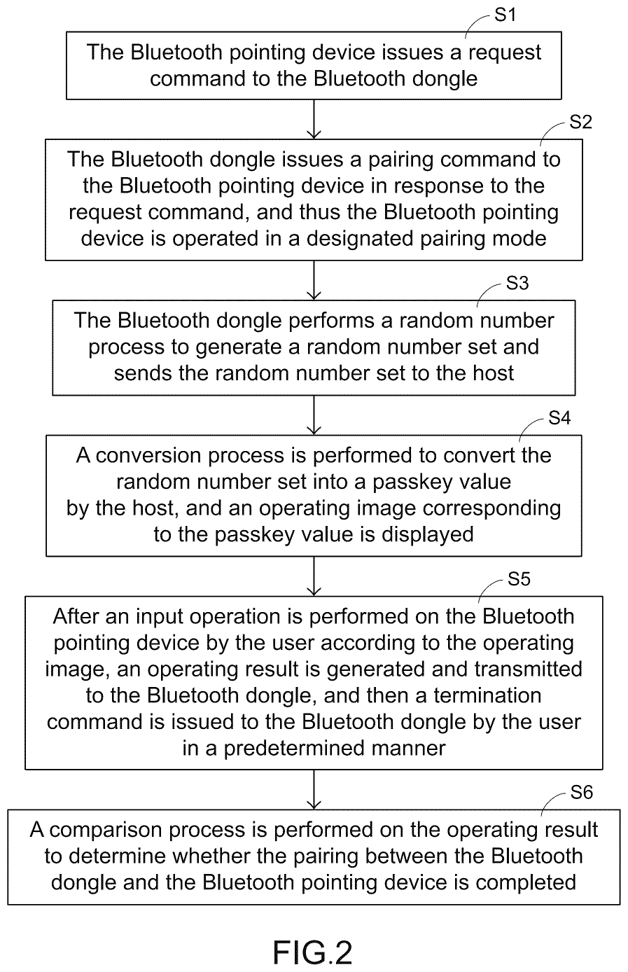

FIG. 2 is a flowchart of a Bluetooth pointing device pairing method according to an embodiment of the present invention.

Firstly, in a step S1, the Bluetooth pointing device 3 issues a request command to the Bluetooth dongle 20.

Then, in a step S2, the Bluetooth dongle 20 issues a pairing command to the Bluetooth pointing device 3 in response to the request command, and thus the Bluetooth pointing device 3 is operated in a designated pairing mode.

Then, in a step S3, the Bluetooth dongle 20 performs a random number process to generate a random number set and sends the random number set to the host 10.

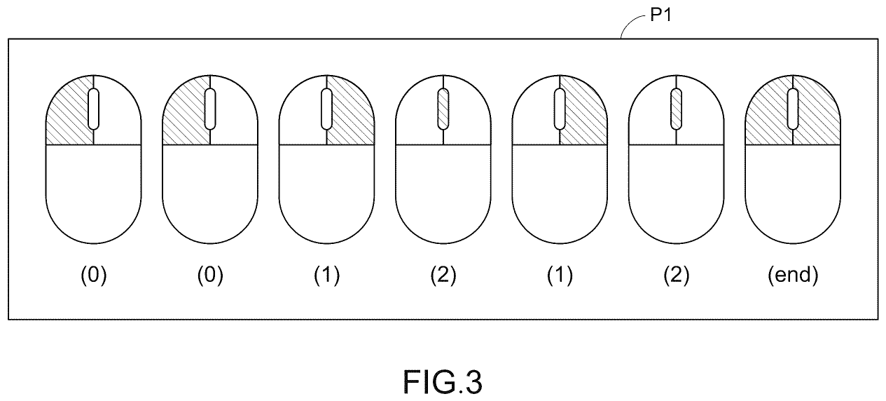

Then, in a step S4 and in FIG. 3, a conversion process is performed to convert the random number set into a passkey value by the host 10, and an operating image PI corresponding to the passkey value is displayed.

Then, in a step S5, an input operation is performed on the Bluetooth pointing device 3 by the user according to the operating image P1, and thus an operating result is generated and transmitted to the Bluetooth dongle 20. Then, a termination command is issued to the Bluetooth dongle 20 by the user in a predetermined manner.

Then, in a step S6, the Bluetooth dongle 20 and the Bluetooth pointing device 3 perform a comparison process on the operating result to determine whether the pairing between the Bluetooth dongle 20 and the Bluetooth pointing device 3 is completed.

In the step S1, the request command is issued after the user turns on the Bluetooth pointing device 3. Consequently, the Bluetooth pointing device 3 issues the request command to find a dongle that can be paired with. Furthermore, in case that other hosts installed with Bluetooth dongles in the user's environment are in operation, the Bluetooth pointing device 3 of the user has to find the corresponding and correct Bluetooth dongle 20 for pairing. Consequently, the mispairing problem can be avoided.

As mentioned above, the purpose of issuing the request command is to find the corresponding Bluetooth dongle 20. In addition, the request command contains input and output capability information corresponding to the Bluetooth pointing device 3. The input and output capability information represents the hardware design of the input and output functions of the Bluetooth pointing device 3. In this embodiment, the Bluetooth pointing device 3 is a mouse device. For example, as shown in FIG. 1, the Bluetooth pointing device 3 is a mouse device with three buttons. According to the input and output capability information, the Bluetooth dongle 20 is informed that the Bluetooth pointing device 3 has three buttons.

Generally, during the pairing process of the conventional Bluetooth low energy mouse, the host is informed that the Bluetooth low energy mouse does not have the input and output functions and only supports the Just Works pairing mode. In accordance with another feature of the present invention, the Bluetooth pointing device 3 is allowed to be considered as a built-in numeric keyboard with plural keys during the pairing process. Consequently, the Bluetooth pointing device 3 is enabled to support the passkey entry pairing mode. In other words, according to the input and output capability information, the Bluetooth dongle 20 is informed that the capability of the Bluetooth pointing device 3 is a numeric keyboard with three keys. Consequently, the Bluetooth pointing device 3 has the feature of avoiding the man-in-the-middle (MITM) attacks.

In the step S2, the designated pairing mode is the passkey entry pairing mode. That is, after the pairing command from the Bluetooth dongle 20 is received by the Bluetooth pointing device 3, the Bluetooth pointing device 3 is informed that the pairing procedures and the operations of both parties will be performed in the passkey entry pairing mode.

In the step S3, the random number process is any random number generation method in any numerical mode. In addition, the random number process can be stored in a flash memory of the Bluetooth dongle 20 as an operation program code. In an embodiment, the generated random number set contains a first random number and a second random number. The first random number and the second random number are in a decimal system. In addition, the value of the first random number is within a first range, and the value of the second random number is within a second range. The second range is correlated with the first range. For example, the first random number is a, and the second random number is b.

The first range and the second range may be expressed by the following formulae:

$$1 ≦ a ≦ 12 \qquad ( 1 )$$

$$0 ≦ b ≦ {3}^{a} - 1 \qquad ( 2 )$$

According to the formula (1) and the formula (2), the first random number is in the range between 1 and 12, and the second random number is in the range between 0 and (3^{a}−1). In this embodiment, the first random number is generated first, and then the second random number is generated. In addition, the random numbers are selected within the ranges defined by the formula (1) and the formula (2).

In accordance with a further feature of the present invention, the generated first random number represents a designated number of input times in the passkey entry pairing mode, i.e., the number of times that the user needs to press or input the button of the Bluetooth pointing device 3. In addition, the second random number represents a designated input password in the passkey entry pairing mode, i.e., the content that the user needs to press through the button of the Bluetooth pointing device 3.

Furthermore, the conditions of the first range and the second range, especially the upper limits of the first range and the second range, are correlated with the number of buttons of the Bluetooth pointing device 3. In this embodiment, the Bluetooth pointing device 3 has three buttons, and thus the number of buttons associated with the Bluetooth pointing device 3 is 3. Accordingly, the upper limit of the second range is designed as (3^{a}−1). In order to avoid too many presses, it is designed that (3^{a}−1) is no greater than 999999. Consequently, the exponent “a”, i.e., the maximum value of the first random number, can reach 12 because 3¹²−1=531440. That is, the upper limit of the first range is 12.

For example, the number of buttons is N. The relationship between the number of buttons (or keys) and the first random number can be expressed as follows:

$${N}^{a} - 1 ≦ 999999 \qquad ( 3 )$$

For example, the first random number selected through the random number process is “6”. It means that the user needs to press the buttons (i.e., the left button 30, the middle button 32 and/or the right button 31) six times in the subsequent process. Then, the upper limit of the second random number is obtained to be 728, i.e., (3⁶−1)=728. That is, any number between 0 and 728 can be selected as the second random number. For example, the second random number selected through the random number process is “50”. It means that the user needs to press the buttons (i.e., the left button 30, the middle button 32 and/or the right button 31) to produce the content representing “50” in the subsequent process.

The procedures of the step S4 will be described in more details as follows. After the random number set from the Bluetooth dongle 20 is received by the host 10, the second random number in the random number set is converted through the conversion process. In this embodiment, the conversion process is used to convert the second random number into the passkey value through a base system conversion. In addition, a base system number used in the conversion process is the number of buttons of the Bluetooth pointing device 3, i.e., 3. In other words, when the Bluetooth dongle 20 sends the random number set (i.e., the first random number and the second random number) to the host 10, the input and output capability information (i.e., the information about the number of buttons) is also transmitted to the host 10.

Consequently, this conversion process is a ternary conversion process. In case that the designated input password (i.e., the second random number) in decimal notation is “50”, its ternary notation is “1212”. Since the first random number is “6”, the designated number of input times represented by the first random number is “6”. That is, six pressing actions are required. Since the value “1212” obtained through the conversion process is a four-digit value, 0 needs to be added in front of the four-digit value. In order words, the four-digit value is converted into the six-digit value “001212”. The value “001212” is the passkey value, i.e., the contents to be pressed.

In accordance with another feature of the present invention, the passkey value is related to the hardware conditions of the three buttons and expressed in the ternary notation. Consequently, each button of the Bluetooth pointing device 3 will be assigned to a numeric key during the pairing process. For example, the left button 30 is assigned to the numeric key “0”, the right button 31 is assigned to the numeric key “1”, and the middle button 32 is assigned to the numeric key “2”.

FIG. 3 is a schematic diagram illustrating the operating image P1 shown on the display screen 11 of the host 10. As shown in FIG. 3, the operating image P1 displays the corresponding button positions that need to be pressed on the display screen 11 according to the passkey value. That is, when the host 10 executes the operating program, the operating method corresponding to the value “001212” is shown in the operating image P1.

In this embodiment, the operating image P1 contains plural static images in a continuous manner. As shown in FIG. 3, plural mouse images are contained in the operating image P1. Each digital number in the passkey value is related to one button of the corresponding mouse to be pressed, and each digital number is prompted in reverse black (or conspicuous) color. The arrangement of the digital numbers in the passkey value are in the order from left to right. That is, the digital numbers in the passkey value are in the order from the highest digit to the lowest digit.

The procedures of the step S5 in FIG. 2 will be described in more details as follows. When the input operation is performed, the user views the operating image P1 and operates the Bluetooth pointing device 3 according to the prompts of the operating image P1. That is, the user presses the corresponding buttons in sequence. For example, as shown in FIG. 3, the left button 30, the left button 30, the right button 31, the middle button 32, the right button 31 and the middle button 32 are pressed sequentially. Consequently, when these buttons are sequentially pressed in response to the input operation, the operating result includes a series of notification signals generated by the Bluetooth pointing device 3 in sequence. These notification signals are sequentially transmitted to the Bluetooth dongle 20 after six pressing actions are sequentially done.

As mentioned above, in the pairing method of the present invention, the termination command is issued to the Bluetooth dongle 20 in the predetermined manner. For example, in the predetermined manner, after the last digital number “2” corresponding to the middle button 32 is pressed, two buttons are pressed simultaneously. In the operating image P1 shown in FIG. 3, the left button and the right button of the last mouse are highlighted in black as the prompt message. After the user presses the left button 30 and the right button 31 simultaneously, the termination command is issued to the Bluetooth dongle 20. Meanwhile, the input operation is completed.

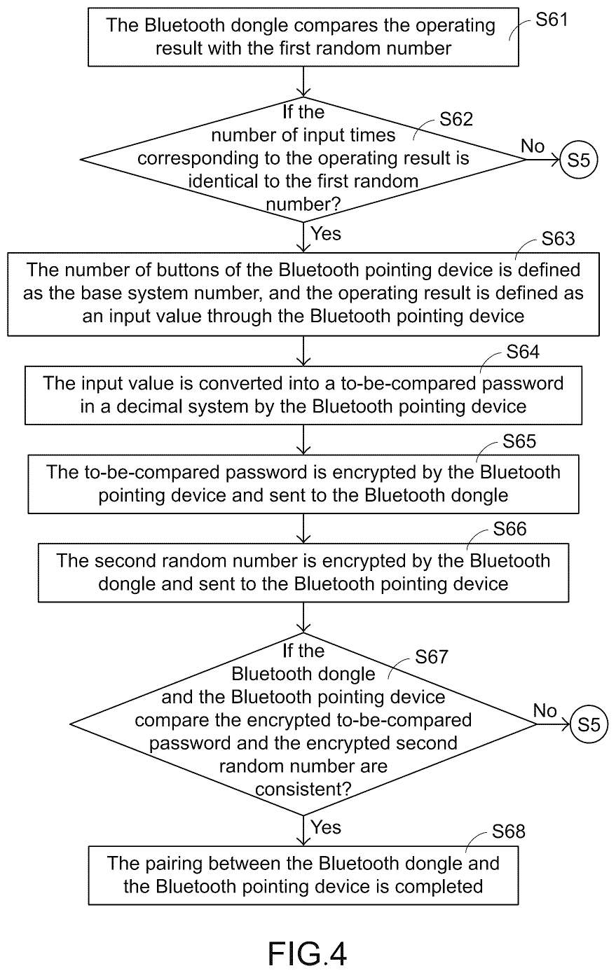

The procedures of the step S6 in FIG. 2 will be described in more details as follows. FIG. 4 is a flowchart of the comparison process in the Bluetooth pointing device pairing method according to the embodiment of the present invention. In this embodiment, the comparison process is performed by the Bluetooth dongle 20 and the Bluetooth pointing device 3 collaboratively. The comparison process to determine whether the Bluetooth dongle 20 and the Bluetooth pointing device 3 are correctly paired with each other.

As shown in FIG. 4, the comparison process includes the following steps.

Firstly, in a step S61, the Bluetooth dongle 20 compares the operating result with the first random number.

Then, a step S62 is performed to judge whether the number of input times corresponding to the operating result is identical to the first random number.

If the number of input times corresponding to the operating result is identical to the first random number, the procedures of the comparison process will be continuously done.

Then, in a step S63, the number of buttons of the Bluetooth pointing device 3 is defined as the base system number, and the operating result is defined as an input value through the Bluetooth pointing device 3.

Then, in a step S64, the input value is converted into a to-be-compared password in a decimal system by the Bluetooth pointing device 3.

Then, in a step S65, the to-be-compared password is encrypted by the Bluetooth pointing device 3 and sent to the Bluetooth dongle 20.

Then, in a step S66, the second random number is encrypted by the Bluetooth dongle 20 and sent to the Bluetooth pointing device 3.

Then, in a step S67, both of the Bluetooth dongle 20 and the Bluetooth pointing device 3 compare whether the encrypted to-be-compared password and the encrypted second random number are consistent.

If the encrypted to-be-compared password and the encrypted second random number are consistent, the pairing between the Bluetooth dongle 20 and the Bluetooth pointing device 3 is completed (Step S68).

In the steps S61 and S62, the first random number representing the designated number of input times is generated by the Bluetooth dongle 20. Consequently, after the operating result representing the press number (i.e., the number of input times) of the user is received by the Bluetooth dongle 20, the Bluetooth dongle 20 will compare the operating result with the first random number and judge whether the operating result and the first random number are identical.

If the number of times the user presses a single button (excluding the action of simultaneously pressing two buttons at the end) within a specified time period is greater than or less than the length of the first random number, it means that the user's input is incorrect. For example, if the first random number is “6” and the press number of the user is five or seven, it means that the user's input is incorrect. Under this circumstance, the Bluetooth dongle 20 and the Bluetooth pointing device 3 cannot be correctly paired, or there may be an incorrect pairing relationship. If the above situation happens, the step S5 of FIG. 2 is repeatedly done. That is, the user needs to press the button once for input again. It is noted that numerous modifications may be made. For example, in another embodiment, the step S3 of FIG. 2 is repeatedly done. That is, the Bluetooth dongle 20 generates a random number set again. Alternatively, the pairing process is directly ended.

In the step S63, S64 and S65, the operating result representing the user's pressing content (i.e., the input content) is generated by the Bluetooth pointing device 3. Consequently, the operating result can be recorded and processed by the Bluetooth pointing device 3 itself. If the user does not press the wrong button, the Bluetooth pointing device 3 will process the above input operation of pressing the left button, pressing the left button, pressing the right button, pressing the middle button, pressing the right button and pressing the middle button in the ternary system according to the passkey entry pairing mode. Consequently, the 6-digit input value “001212” is reversely obtained.

As mentioned above, the input value “001212” is converted into the to-be-compared password “50” by the Bluetooth pointing device 3 according to the decimal system conversion. During the conversion process, the input value is a ternary value, and the corresponding value shown on the display screen 11 is also ternary. However, in order to pair the Bluetooth pointing device 3 and the Bluetooth dongle 20 with each other, the designated input password (i.e., the second random number) generated by the Bluetooth dongle 20 is the information to be compared. That is, the input value needs to be converted into the to-be-compared password in a decimal system by the Bluetooth pointing device 3. Then, the to-be-compared password is encrypted by the Bluetooth pointing device 3.

In the steps S66, S67 and S68, the comparison method is designed according to the decimal system. Consequently, the second random number in the decimal system is encrypted by the Bluetooth dongle 20. Then, the encrypted information of the Bluetooth dongle 20 and the encrypted information of the Bluetooth pointing device 3 are exchanged. That is, the encrypted to-be-compared password is issued to the Bluetooth dongle 20, and the encrypted second random number is issued to the Bluetooth pointing device 3. Consequently, both parties can perform the comparison process according to the respective obtained information. In other words, if the user does not press the wrong button, the to-be-compared password and the second random number are consistent, i.e., “50”. Meanwhile, both parties are successfully paired with each other.

Whereas, if the user presses the wrong button, the to-be-compared password and the second random number are inconsistent. Under this circumstance, the Bluetooth dongle 20 and the Bluetooth pointing device 3 are not successfully paired with each other. Similarly, if the above situation happens, the step S5 of FIG. 2 is repeatedly done. It is noted that numerous modifications may be made. For example, in another embodiment, the step S3 of FIG. 2 is repeatedly done. Alternatively, the pairing process is directly ended.

However, in some situations, the ternary passkey value has fewer effective digits, but the designated number of input times (i.e., the first random number) has more effective digits. Under this circumstance, it is necessary to fill the effective digits with 0. For example, in case the input value pressed by the user is “1212”, the input value is converted into “50” in the decimal system. Although the designated input password (i.e., the second random number) is equal to “50”, the press number is four. Since the press number is not equal to the designated number of input times (i.e., the first random number “6”), both parties are not successfully paired with each other. Consequently, the comparing steps S61 and S62 needs to be performed first.

In accordance with the present invention, anyone who can see the operating image Pl on the display screen 11 can know the paired passkey value. Although a man-in-the-middle (MITM) attack may occur from the simultaneous use of other user's Bluetooth devices and the number of input times of the passkey value is more likely to be accidentally pressed, the content of the complete passkey value is extremely difficult to guess.

Generally, in the entire pairing process, the Bluetooth dongle 20 generates random numbers according to conditions, the host 10 converts and displays the corresponding numbers for the user to view, and then the user presses the Bluetooth pointing device 3 to correspondingly input the random numbers that match the random numbers generated by the Bluetooth dongle 20. Consequently, the Bluetooth pointing device 3 can be effectively operated in the passkey entry pairing mode. The technology of the present invention can have the information security protection function of avoiding man-in-the-middle (MITM) attacks without using additional hardware configuration.

Furthermore, the digit number or the length of the random number generated during each pairing process is possibly changed, and the content of the random number may also be different. The technology of the present invention is different from the conventional passkey entry pairing mode with a fixed digit number or length. The technology of the present invention can not only provide a higher passkey security coefficient, but also better prevent man-in-the-middle attacks or avoid pairing errors.

The present invention can also be altered and modified according to the concepts disclosed in the above embodiments while achieving the same or similar development goals and effects.

For example, the Bluetooth pointing device may have other number of buttons. For example, in some other embodiments, the Bluetooth pointing device has 2 or 5 buttons. In addition, the upper limit of the second range in the above formula (2) can be changed according to the number of buttons. For example, in case that the number of buttons is 2, the upper limit of the second range becomes (2^{a}31 1). Similarly, in case that the number of buttons is 5, the upper limit of the second range becomes (5^{a}−1). The upper limit of the first range can be set according to the above formula (3). For example, in case that the number of buttons is 2, the maximum value of the first random number can reach 19 (because 2¹⁹−1=524287). That is, the upper limit of the first range is 19.

In the above embodiment, the user presses the buttons to perform the input operation on the Bluetooth pointing device. In some other embodiments, the user moves the Bluetooth pointing device in specified directions (e.g., left/right or forward/backward directions) to perform the input operation on the Bluetooth pointing device. Under this circumstance, the operating image on the display screen not only contains the buttons to be pressed but also displays the operating method of the Bluetooth pointing device. When the input operation is performed, the user can press the corresponding buttons of the Bluetooth pointing device according to the prompts of the operating image. In addition, the user can move the Bluetooth pointing device according to the prompts of the operating image.

As mentioned above, the termination command is issued to the Bluetooth dongle in the predetermined manner. The predetermined manner is not restricted. For example, in another embodiment of the predetermined manner, the user can press the left button 30, the middle button 32 and the right button 31 simultaneously to issue the termination command. Under this circumstance, the three buttons of the last mouse in the operating image are highlighted in black as the prompt message. Alternatively, in another embodiment of the predetermined manner, the user does not press any button or move the Bluetooth pointing device for a specified time period after the input operation is completed. That is, no action is taken after the input operation is completed. In this case, it is feasible to display the images corresponding to the passkey value on the operating image.

From the above descriptions, the present invention provides a Bluetooth pointing device pairing method. This pairing method allows a Bluetooth low energy (BLE) device to be effectively paired with a dongle in a passkey entry pairing mode complying with the Bluetooth transmission standard without the need of adding additional hardware configurations. As a consequence, the hardware setup cost is reduced, and the information security protection function to avoid the man-in-the-middle (MITM) attacks is achieved. Furthermore, since random numbers are generated in each pairing process, the technology of the present invention can not only provide a higher passkey security coefficient, but also better prevent man-in-the-middle attacks or avoid pairing errors.

In other words, the Bluetooth pointing device pairing method is capable of effectively overcoming the drawbacks of the conventional technologies and achieving the purposes of the present invention.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A Bluetooth pointing device pairing method for a host, a Bluetooth dongle and a Bluetooth pointing device, the Bluetooth dongle being in communication with the host, the Bluetooth pointing device pairing method comprising steps of:
issuing a request command from the Bluetooth pointing device to the Bluetooth dongle;
issuing a pairing command from the Bluetooth dongle to the Bluetooth pointing device in response to the request command, so that the Bluetooth pointing device is operated in a designated pairing mode;
performing a random number process to generate a random number set by the Bluetooth dongle, and sending the random number set to the host;
performing a conversion process to convert the random number set into a passkey value by the host, and displaying an operating image corresponding to the passkey value;
performing an input operation on the Bluetooth pointing device by a user according to the operating image, so that an operating result is generated, wherein after the operating result is transmitted to the Bluetooth dongle, a termination command is issued to the Bluetooth dongle by the user in a predetermined manner; and
the Bluetooth dongle and the Bluetooth pointing device performing a comparison process on the operating result to determine whether a pairing between the Bluetooth dongle and the Bluetooth pointing device is completed.

2. The Bluetooth pointing device pairing method according to claim 1, wherein the Bluetooth pointing device is a mouse device with plural buttons, and the Bluetooth pointing device and the Bluetooth dongle are optionally integrated as a Bluetooth pointing module.

3. The Bluetooth pointing device pairing method according to claim 1, wherein the request command contains input and output capability information corresponding to the Bluetooth pointing device.

4. The Bluetooth pointing device pairing method according to claim 1, wherein the host includes a display screen, and the operating image is shown on the display screen, wherein an operating program corresponding to the Bluetooth pointing device and the Bluetooth dongle is loaded in the host, and the conversion process is performed when the operating program is executed.

5. The Bluetooth pointing device pairing method according to claim 4, wherein the Bluetooth pointing device comprises plural buttons, wherein when the operating program is executed, the operating image is shown on the display screen, wherein the operating image is an image about the corresponding buttons to be pressed according to the passkey value or about an operating method for the Bluetooth pointing device.

6. The Bluetooth pointing device pairing method according to claim 5, wherein when the input operation is performed, the user presses the corresponding buttons according to the operating image, or the user moves the Bluetooth pointing device according to the operating image.

7. The Bluetooth pointing device pairing method according to claim 5, wherein when two of the plural buttons of the Bluetooth pointing device are pressed simultaneously or the user has not pressed any button or has not moved the Bluetooth pointing device for a specified time period, the termination command is issued in the predetermined manner.

8. The Bluetooth pointing device pairing method according to claim 1, wherein the Bluetooth pointing device comprises plural buttons, and the designated pairing mode is the passkey entry pairing mode, wherein the random number set contains a first random number and a second random number, and the first random number and the second random number are in a decimal system, wherein a value of the first random number is within a first range, a value of the second random number is within a second range, and the second range is correlated with the first range.

9. The Bluetooth pointing device pairing method according to claim 8, wherein the first random number represents a designated number of input times in the passkey entry pairing mode, and the second random number represents a designated input password in the passkey entry pairing mode.

10. The Bluetooth pointing device pairing method according to claim 8, wherein a condition of the first range and a condition of the second range are correlated with a number of buttons of the Bluetooth pointing device.

11. The Bluetooth pointing device pairing method according to claim 8, wherein when the conversion process is performed, the second random number is converted into the passkey value through a base system conversion, and a base system number used in the conversion process is identical to a number of buttons of the Bluetooth pointing device.

12. The Bluetooth pointing device pairing method according to claim 8, wherein the comparison process comprises steps of:
comparing the operating result with the first random number by the Bluetooth dongle; and
if a number of input times corresponding to the operating result is identical to the first random number, continuously performing the comparison process.

13. The Bluetooth pointing device pairing method according to claim 12, wherein the comparison process further comprises steps of:
defining a number of buttons of the Bluetooth pointing device as a base system number, and defining the operating result as an input value through the Bluetooth pointing device;
converting the input value into a to-be-compared password in a decimal system by the Bluetooth pointing device;
encrypting the to-be-compared password by the Bluetooth pointing device, and sending the encrypted to-be-compared password to the Bluetooth dongle;
encrypting the second random number by the Bluetooth dongle, and sending the encrypted second random number to the Bluetooth pointing device;
the Bluetooth dongle and the Bluetooth pointing device comparing whether the encrypted to-be-compared password and the encrypted second random number are consistent; and
if the encrypted to-be-compared password and the encrypted second random number are consistent, determining that the pairing between the Bluetooth dongle and the Bluetooth pointing device is completed.
